(19) United States
(12) Patent Application Publication
(10) Pub. No.: US 2025/0106881 A1
(43) Pub. Date: Mar. 27, 2025

(54) FREQUENCY RANGE ALLOCATION TO REDUCE INTERFERENCE IN USER EQUIPMENT IN PROXIMITY TO ONE ANOTHER

(71) Applicant: Charter Communications Operating, LLC, St. Louis, MO (US)

(72) Inventor: Pareshkumar Panchal, Highlands Ranch, CO (US)

(21) Appl. No.: 18/475,319

(22) Filed: Sep. 27, 2023

(51) Int. Cl. H04W 72/541; H04W 72/0453; H04W 72/543

(52) U.S. Cl. CPC H04W 72/541; H04W 72/0453; H04W 72/543

(57) ABSTRACT

Real-time metrics of a first user equipment (UE) being served by a first base station and a second UE being served by a second base station are accessed. A proximity determination, based on the real-time metrics, is made that the first UE and the second UE are in proximity to one another. Based at least in part on the proximity determination, instructions are sent to the first base station and the second base station that cause the first base station to utilize a first frequency range for communications with the first UE and the second base station to utilize a second frequency range for communications with the second UE, wherein the first frequency range and the second frequency range do not overlap in frequency.

### BACKGROUND

Two user equipment (UE) such as mobile phones, may be served by different base stations in adjacent cells. The UEs may each be near an edge of their respective cell, and thus in relatively close proximity to one another. The UEs may cause interference with each other while receiving or transmitting data on or near the same frequency ranges.

### SUMMARY

The examples disclosed herein implement a resource allocation manager (RAM) that identifies when first and second UEs in neighboring cells are in proximity to one another and possibly interfering with one another. The RAM may send instructions to base stations that cause the base stations to communicate with the UEs using different frequency ranges.

In one implementation a method is provided. The method includes accessing, by a computing device, real-time metrics of a first user equipment (UE) being served by a first base station and a second UE being served by a second base station. The method further includes making a proximity determination, by the computing device based on the real-time metrics, that the first UE and the second UE are in proximity to one another. The method further includes, based at least in part on the proximity determination, sending instructions to the first base station and the second base station that cause the first base station to utilize a first frequency range for communications with the first UE and the second base station to utilize a second frequency range for communications with the second UE, wherein the first frequency range and the second frequency range do not overlap in frequency.

In another implementation a computing device is provided. The computing device includes a memory, and a processor device coupled to the memory and operable to access real-time metrics of a first user equipment (UE) being served by a first base station and a second UE being served by a second base station. The processor device is further operable to make a proximity determination based on the real-time metrics that the first UE and the second UE are in proximity to one another. The processor device is further operable to, based at least in part on the proximity determination, send instructions to the first base station and the second base station that cause the first base station to utilize a first frequency range for communications with the first UE and the second base station to utilize a second frequency range for communications with the second UE, wherein the first frequency range and the second frequency range do not overlap in frequency.

In another implementation a non-transitory computer-readable storage medium is provided. The non-transitory computer-readable storage medium includes executable instructions operable to cause a processor device to access real-time metrics of a first user equipment (UE) being served by a first base station and a second UE being served by a second base station. The instructions are further operable to cause the processor device to make a proximity determination based on the real-time metrics that the first UE and the second UE are in proximity to one another. The instructions are further operable to cause the processor device to, based at least in part on the proximity determination, send instructions to the first base station and the second base station that cause the first base station to utilize a first frequency range for communications with the first UE and the second base station to utilize a second frequency range for communications with the second UE, wherein the first frequency range and the second frequency range do not overlap in frequency.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of an environment in which frequency range allocation to reduce interference in user equipment in proximity to one another can be practiced according to one implementation;

FIG. 2 is diagram illustrating an allocation of frequency ranges according to one example;

FIG. 3 is a diagram illustrating resource block usage of three base stations in accordance with the instructions sent to the base stations;

FIG. 4 is diagram illustrating an allocation of frequency ranges according to another example;

FIG. 5 is diagram illustrating an allocation of frequency ranges

according to another example wherein network slices are taken into consideration;

FIG. 6 is a flowchart of a method for frequency range allocation to reduce interference in user equipment in proximity to one another according to one implementation; and

FIG. 7 is a block diagram of a computing device suitable for implementing examples according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Two user equipment (UE) such as mobile phones, may be served by different base stations in adjacent cells. The UEs may each be near an edge of their respective cell, and thus in relatively close proximity to one another. The UEs may cause interference with each other while receiving or transmitting data on or near the same frequency ranges.

5G (5^{th} generation mobile network) service providers are increasingly using network slices to serve different classes of UEs, and/or to provide quality of service (QOS) guarantees to customers. The term “network slice” as used herein refers to the ability to implement multiple virtual networks on top of a physical network in 5G. Each network slice may service different types of devices, or different customers. By way of non-limiting example, the following 5G service types use network slices to implement differential handling of traffic:

Enhanced Mobile Broadband, or eMBB, provides mobile data access in one of three ways: to dense collections of users, to highly mobile users and to users spread over wide areas. It relies on features such as large arrays of multiple input, multiple output (MIMO) antennas and the combination of spectra starting with conventional 4G wavelengths and stretching into the millimeter band; Massive Machine-Type Communications, or mMTC, services are built to serve massive numbers of devices in a small area with the expectation that they generate little data (about tens of bytes per second) and can tolerate high latency (up to 10 seconds on a round trip); and Ultrareliable low-latency communications, or URLLC, uses 5G to deliver secure communications with latencies of 1 millisecond (ms) and high reliability with low, or even zero, packet loss.

It is desirable, and perhaps contractually required, for a service provider to ensure that a UE has the transmission characteristics commensurate with the network slice to which the UE has been assigned. For example, if a first UE being served by a first base station is assigned a network slice that guarantees a high bandwidth, interference from a second UE served by a neighboring base station may inhibit the ability of the service provider to provide the guaranteed bandwidth to the first UE. However, if the first UE is assigned to a low bandwidth, high latency network slice, the interference from the second UE may not be problematic.

The examples disclosed herein implement a resource allocation manager (RAM) that identifies when first and second UEs in neighboring cells are in proximity to one another and possibly interfering with one another. In one implementation, the RAM accesses real-time metrics of the first UE and the second UE. The RAM determines that the first UE and the second UE are being served by respective first and second neighboring base stations, and thus the first base station serving the first UE is not aware that the second base station serving the second UE may be using the same or overlapping frequency ranges as that used by the first base station to serve the first UE. The RAM also makes a proximity determination, based on information contained in the real-time metrics, that the first UE is in proximity to the second UE. Based at least in part on the proximity determination, the RAM may send instructions to the first base station and the second base station that cause the first base station to use a first frequency range, such as a first set of resource blocks, to communicate with the first UE, and the second base station to use a second frequency range, such as a second set of resource blocks, to communication with the second UE.

This process may be repeated every millisecond, every ten milliseconds, every second, every five seconds, or the like, until the RAM determines that the first UE and the second UE are no longer in proximity to one another. In some implementations, the RAM may utilize network slice information to determine the particular frequency ranges to assign to a UE.

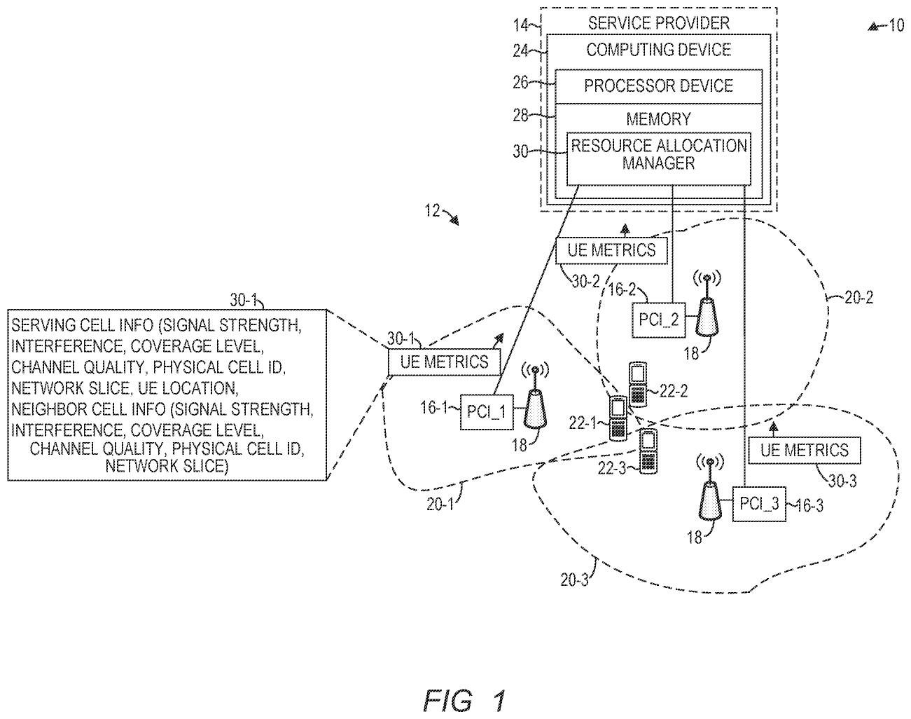

FIG. 1 is a block diagram of an environment 10 in which frequency range allocation to reduce interference in user equipment in proximity to one another can be practiced according to one implementation. The environment 10 includes a cellular network 12, such as, by way of non-limiting example, a 5G cellular network operated by a service provider 14. The cellular network 12 includes a plurality of base stations 16-1-16-3 (generally, base stations 16), each of which has a corresponding physical cell ID (e.g., PCI_1, PCI_2, PCI_3). Each base station 16 includes, or is coupled to, an antenna 18 that is operable to transmit data to and receive data from one or more UEs. The base station 16-1 has a serving area represented generally by a dashed line 20-1, the base station 16-2 has a serving area represented generally by a dashed line 20-2, and the base station 16-3 has a serving area represented generally by a dashed line 20-3.

At the point in time illustrated in FIG. 1, the UE 22-1 is a mobile smart phone and is being served by the base station 16-1, the UE 22-2 is a mobile smart phone and is being served by the base station 16-2, and the UE 22-3 is a mobile smart phone and is being served by the base station 16-3. As illustrated, each of the UEs 22-1-22-3 are near the outer reaches (e.g., edges) of the respective serving areas 20-1-20-3, and are in close proximity to one another. While in practice the bases stations 16 may each be serving tens or hundreds of UEs simultaneously, for purposes of illustration only the UEs 22-1-22-3 will be discussed herein.

Periodically, such as every 500 milliseconds, every second, every five seconds, or the like, the UE 22-1 sends real-time metrics that quantify signal characteristics between the UE 22-1 and the base station 16-1 that include, by way of non-limiting example, serving cell signal strength, interference metrics, coverage level metrics, channel quality metrics, physical cell id associated with the base station 16-1, network slice identifier of the network slice to which the UE 22-1 has been assigned, and device location information that identifies a current location of the UE 22-1. The UE 22-1 may also send real-time metrics that quantify signal characteristics between the UE 22-1 and the base station 16-2 that include, by way of non-limiting example, interference metrics, coverage level metrics, channel quality metrics, physical cell id associated with the base station 16-2. The UE 22-1 may also send real-time metrics that quantify signal characteristics between the UE 22-1 and the base station 16-3 that include, by way of non-limiting example, interference metrics, coverage level metrics, channel quality metrics, physical cell id associated with the base station 16-3. The UE 22-2 similarly provides such metrics to the serving base station 16-2, and the UE 22-3 similarly provides such metrics to the serving base station 16-3.

The service provider 14 operates a computing device 24 that includes a processor device 26 and a memory 28. A resource allocation manager (RAM) 30 executes in the memory 28. As will be discussed in greater detail below, the RAM 30, based on one or more trigger conditions, may send instructions to the base stations 16-1-16-3 at times to attempt to reduce interference between UEs 22 being serviced by the base stations 16-1-16-3. The base station 16-1 sends real-time metrics 32-1 to the RAM 30 periodically, such as every 500 ms, every second, or other suitable interval. The real-time metrics 32-1 include the real-time metrics discussed above with regard to the UE 22-1 and any other UEs 22 served by the base station 16-1. Similarly, the base station 16-2 sends real-time metrics 32-2 to the RAM 30 periodically, and the base station 16-f3 sends real-time metrics 32-3 to the RAM 30 periodically.

For purposes of illustration, assume that at the instant in time illustrated in FIG. 1, the RAM 30 determines the following signal characteristics of the UEs 22-1-22-3 based on accessing the real-time metrics 30-1-30-3.

### UE 22-1

Serving cell PCI _1, signal strength −110 dBm, interference 3.2 dB

Neighbor cell PCI_2, signal strength −113 dBm, interference 2.0 dB

Neighbor cell PCI_3, signal strength −115 dBm, interference 0.0 dB

### UE 22-2

Serving cell PCI _2, signal strength −106 dBm, interference 1.1 dB

Neighbor cell PCI _1, signal strength −109 dBm, interference 0.0 dB

Neighbor cell PCI_3, signal strength −106 dBm, interference −1.0 dB

### UE 22-3

Serving cell PCI _3, signal strength −104 dBm, interference 2.8 dB Neighbor cell PCI _2, signal strength −106 dBm, interference 1.5 dB Neighbor cell PCI _1, signal strength −110 dBm, interference −1.3 dB

The RAM 30 makes a proximity determination that the three UEs 22-1-22-3 are within proximity to one another. The proximity determination may be based, for example, on any suitable criterion or criteria, such as a predetermined distance from one another, or any other criteria via which proximity may be determined, such as triangulation, or the like. The proximity determination may be that each of the UEs 22-1-22-3 are within proximity of the other UEs 22-1-22-3, or that each of the UEs 22-1-22-3 is within proximity of at least one of the other UEs 22-1-22-3. The proximity determination may be a trigger condition for the RAM 30 to send instructions to the base stations 22-1-22-3 to attempt to reduce interference between 22-1-22-3 being serviced by the base stations 16-1-16-3. The RAM 30 may also utilize signal characteristic values, such as serving cell signal strength, service cell interference, or the like, as trigger conditions to send instructions to the base stations 22-1-22-3 to attempt to reduce interference between 22-1-22-3 being serviced by the base stations 16-1-16-3. For example, the RAM 30 may also utilize one or more signal quality determinations, such as based on, for example, signal strength and/or interference levels to determine whether instructions should be sent to the base stations 22-1-22-3 to attempt to reduce interference between 22-1-22-3 being serviced by the base stations 16-1-16-3. For example, the RAM 30 may require that the serving cell signal strength for each of the UEs 22-1-22-3 be non-preferred values, such as less than −100 dBm, or −105 dBm or any other suitable threshold. The RAM 30 may require that the serving cell interference for each of the UEs 22-1-22-3 be non-preferred values, such as less than 5 dB, or any other suitable threshold. The RAM 30 may require that the serving cell signal strength and/or the serving cell interference must remain non-preferred values for a period of time, such as three consecutive seconds, five consecutive seconds, or the like. The RAM 30 may also utilize neighboring cell signal strength as a precondition, such as a first neighbor cell signal strength of +/−3dBm and interference +/−2 dB from the serving cell, and a second neighbor cell signal strength +/−6 dBm and interference +/−4 dB from the serving cell. The RAM 30 may use the proximity determination by itself or with any combination of conditions as discussed above prior to determining that instructions should be sent to the base stations 22-1-22-3 to attempt to reduce interference between 22-1-22-3 being serviced by the base stations 16-1-16-3.

In this example, the RAM 30 sends instructions to the base station 16-1 to utilize a first frequency range for communications with the UE 22-1. The RAM 30 sends instructions to the base station 16-2 to utilize a second frequency range for communications with the UE 22-2 and the RAM 30 sends instructions to the base station 16-3 to utilize a third frequency range for communications with the UE 22-3. The first, second and third frequency ranges do not overlap, and thus interference between the UEs 22-1, 22-2 and 22-3 will be reduced or eliminated. The instructions may have a time duration such as five second, ten seconds, or the like.

The RAM 30 may repeatedly make the proximity determination of whether UEs 22 serviced by the base stations 16-1-16-3 are in proximity to one another, such as every 500 ms, every 1 second, or the like. If the RAM 30 subsequently determines that the UEs 22-1-22-3 are no longer in proximity to one another, or fail to meet one of the other trigger conditions, the RAM 30 inhibits sending instructions to the base stations 16-1-16-3, and the previous instructions may simply expire after a predetermined amount of time. Alternatively, if the RAM 30 subsequently determines that the UEs 22-1-22-3 are still in proximity to one another, the RAM 30 may repeat the instructions to the base stations 16-1-16-3 and consequently reset the time duration.

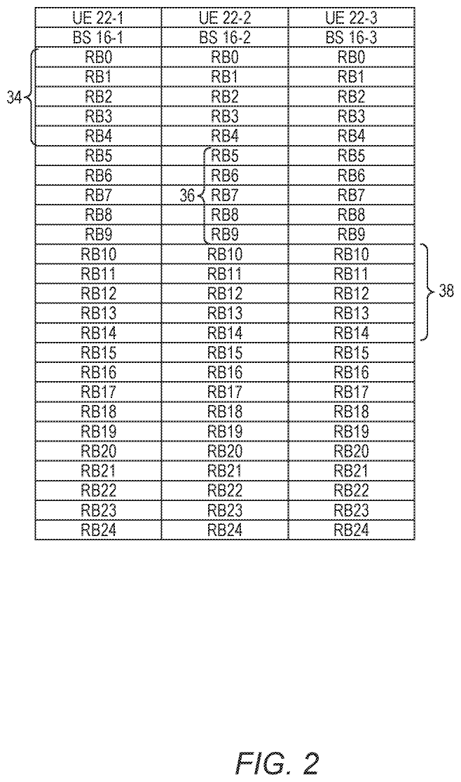

FIG. 2 is diagram illustrating the allocation of frequency ranges according to one example. In this example, the base stations 16-1-16-3 each have the same 5 MHz frequency bandwidth which is allocated into 25 resource blocks, each of which represents a particular time and frequency domain. In this example, the RAM 30 has instructed the base station 16-1 to utilize a frequency range 34 that comprises resource blocks RB0-RB4 for communications with the UE 22-1. The RAM 30 has instructed the base station 16-2 to utilize a frequency range 36 that comprises resource blocks RB5-RB9 for communications with the UE 22-2, and the RAM 30 has instructed the base station 16-3 to utilize a frequency range 38 that comprises resource blocks RB10-RB14 for communications with the UE 22-3. In this manner, the RAM 30 ensures that the UEs 22-1-22-3 are not interfering with one another.

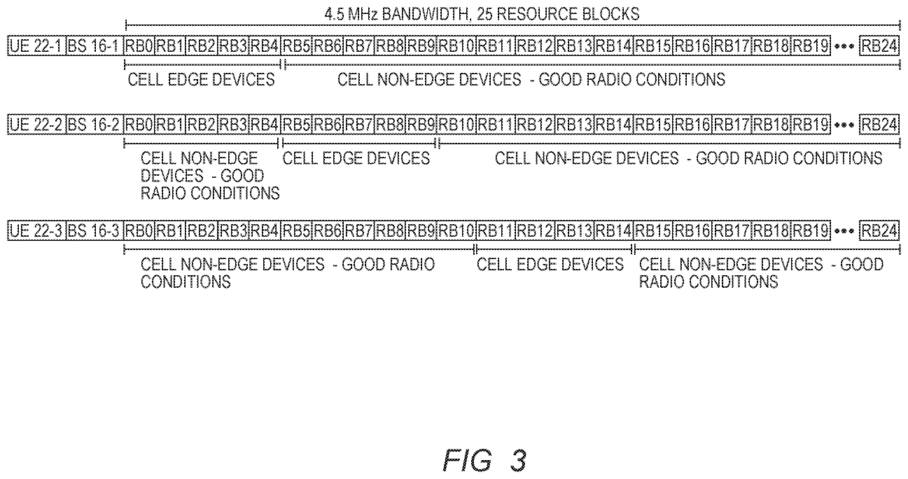

FIG. 3 is a block diagram illustrating resource block usage of the base stations 16-1-16-3 in accordance with the instructions sent to the base stations 16-1-16-3 discussed above with regard to FIG. 2. Subsequent to receiving the instructions from the RAM 30, the base station 16-1 utilizes, for a period of time, resource blocks RBO-RB4 for the edge UE 22-1, and resource blocks RB5-RB24 for UEs that are not near the edges of the serving area 20-1. Subsequent to receiving the instructions from the RAM 30, the base station 16-2 utilizes, for a period of time, resource blocks RB5-RB9 for the edge UE 22-2, and resource blocks RB0-RB4 and RB10-RB24 for UEs that are not near the edges of the serving area 20-2. Subsequent to receiving the instructions from the RAM 30, the base station 16-3 utilizes, for a period of time, resource blocks RB11-RB14 for the edge UE 22-3, and resource blocks RB0-RB10 and RB15-RB24 for UEs that are not near the edges of the serving area 20-3. In this manner, the frequency ranges used by the UEs 22-1-22-3 do not overlap, reducing interference and resulting in a stronger signal.

In some implementations the RAM 30 may also use network slice information to make a network slice determination that a trigger condition has occurred. In particular, each of the UEs 22 may include in the real-time metrics a network slice identifier of the network slice to which the respective UE 22 has been assigned. The RAM 30 may utilize different signal quality metrics based on a particular network slice. For example, if a UE 22 is experiencing relatively strong interference and/or poor signal strength, but has been assigned to a eMBB network slice that has a relatively high guaranteed bandwidth and low latency, the RAM 30 may send instructions to the base stations 16-1-16-3 as described above. In another example, if all the UEs 16-1-16-3 are assigned to a network slice that guarantees only a minimal bandwidth and has no latency requirements, such as an mMTC network slice, the RAM 30 may determine that the relatively strong interference and/or poor signal strength may not prevent the service provider from meeting the guarantees associated with the network slice, and the RAM 30 may not send instructions to the base stations 16-1-16-3. In yet another example, if, for example, the UE 16-1 is assigned to an eMBB network slice and the UEs 16-2 and 16-3 are assigned to an mMTC network slice, the RAM 30 may send instructions that separate the frequency band of the UE 16-1 from the frequency bands of the UEs 16-2-16-3.

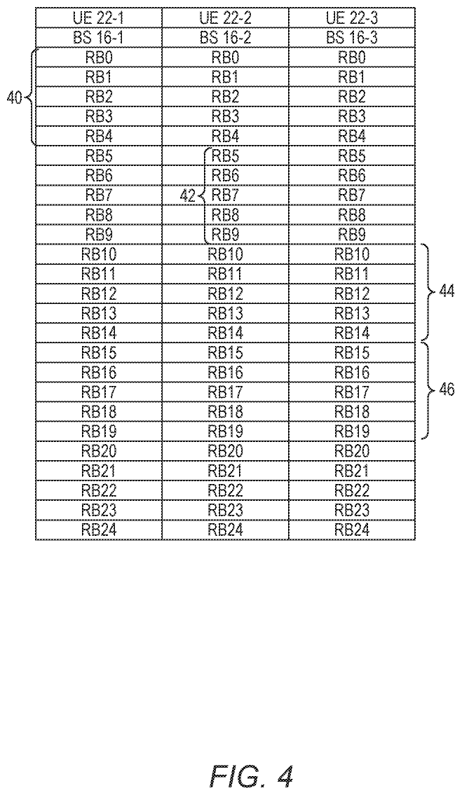

FIG. 4 is diagram illustrating an allocation of frequency ranges according to another example wherein network slices are taken into consideration. In this example, the RAM 30 determines, for example, UEs 22-1 and 22-2 are in a same network slice that requires moderate bandwidth and moderate latency, the UE 22-3 is in a network slice that is contracted to provide a high bandwidth and low latency, and the UEs 22-1-22-3 are in proximity to one another. The RAM 30 determines that each of the UEs 22-1 and 22-2 meet a trigger condition for the particular network slice to which they have been assigned, and the UE 22-3 meets a trigger condition for the particular network slice to which the UE 22-3 has been assigned.

The RAM 30 sends instructions to the base station 16-1 that cause the base station 16-1 to utilize a frequency range 40 comprising resource blocks RB0-RB4 for communications with the UE 22-1. The RAM 30 sends instructions to the base station 16-2 that cause the base station 16-2 to utilize a frequency range 42 comprising resource blocks RB5-RB9 for communications with the UE 22-2. Because the UE 22-3 is in a network slice that is contracted to provide a high bandwidth and low latency, the RAM 30 may implement a frequency gap of at least one resource block between the UE 22-3 and the UEs 22-1 and 22-2. In this example, the RAM 30 implements a frequency gap 44 of the five resource blocks RB10-RB-14, and sends instructions to the base station 16-3 that cause the base station 16-3 to utilize a frequency range 46 comprising resource blocks RB15-RB19 for communications with the UE 22-3. The frequency gap 44 further separates the frequencies used by the UE 22-3 from those used by the UEs 22-1, 22-2 that are in proximity to the UE 22-3, further decreasing a likelihood of interference with the UEs 22-1, 22-2.

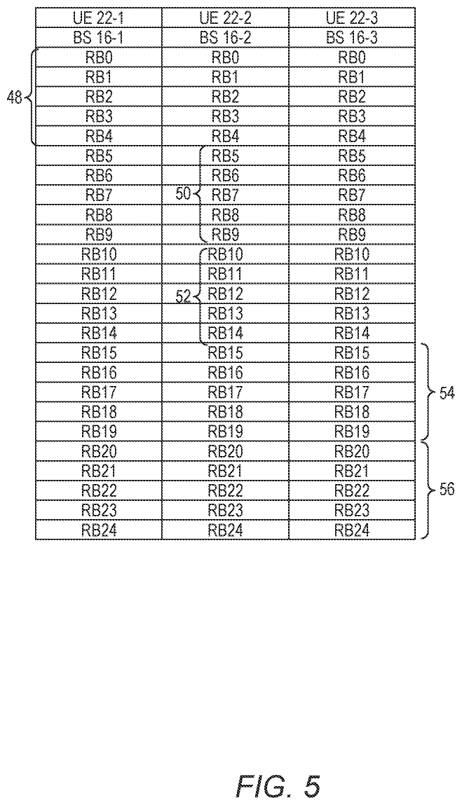

FIG. 5 is diagram illustrating an allocation of frequency ranges according to another example wherein network slices are taken into consideration. In this example, the RAM 30 may determine, for example, that UEs 22-1-22-3 have been assigned to a same network slice that is contracted to provide a high bandwidth and low latency, and the UEs 22-1-22-3 are in proximity to one another. The RAM 30 determines that each of the UEs 22-1-22-3 meet a trigger condition for the network slice. The RAM 30 sends instructions to the base station 16-1 that cause the base station 16-1 to utilize a frequency range 48 comprising resource blocks RB0-RB4 for communications with the UE 22-1. Because the UEs 22-1-22-3 are all in a network slice that is contracted to provide a high bandwidth and low latency, the RAM 30 implements a frequency gap 50 of, in this example, five resource blocks RB5-RB9 between the UE 22-3 and the UEs 22-1 and sends instructions to the base station 16-2 that cause the base station 16-2 to utilize a frequency range 52 comprising resource blocks RB10-RB14 for communications with the UE 22-2. The RAM 30 implements a frequency gap 54, of, in this example, five resource blocks RB15-RB19 between the UE 22-3 and the UEs 22-2 and sends instructions to the base station 16-3 that cause the base station 16-3 to utilize a frequency range 56 comprising resource blocks RB20-RB24 for communications with the UE 22-3.

It is noted that the trigger conditions described herein are simply examples and any suitable conditions may be used by the RAM 30 as trigger conditions. Moreover, while in this example the RAM 30 selected the three base stations 16-1-16-3 to implement a particular frequency allocation strategy, in other examples the RAM 30 may determine that only two UEs in two neighboring cells are interfering, and thus may select only two base stations for a frequency allocation strategy. In yet other examples, the RAM 30 may determine that more then three UEs being served by more than three base stations are interfering with one another and the RAM 30 may include more than three base stations in the allocation strategy and/or more than three network slices. Moreover, it is noted that trigger conditions can be based on network slices of a same type of use case (e.g., eMBB, mMTC, URLLC), or of different types of use cases and/or different types of QoS requirements.

In one implementation, the RAM 30 may determine the strongest two neighbor cells other then the serving cell to identify cells for resource allocation strategy. The RAM 30 may create a group of those three base stations (serving base station plus two neighbor base stations) to be part of the resource allocation alignment. The RAM 30 may categorize UEs based on the network slice to which they are assigned as well as a type of use case they are being associated with (e.g., the RAM 30 may obtain certain network information from configuration information associated with the UEs). The RAM 30 may then create the allocation strategy and communicate with the base stations to implement the frequency allocation strategy.

Other examples of trigger conditions may be the following:
All three UEs devices are part of the same network slice:
   Serving cell signal strength <−100 dBm
   Serving cell interference <5 dB
   Condition timer up to 3 second consecutively
   1^{st} neighbor cell signal strength +/−3 dBm and interference +/−2 dB from serving cell
   2^{nd} neighbor cell signal strength +/−6 dBm and interference +/−4 dB from serving cell
   Similar condition for other two UEs
   In that case, first neighbor cell in above criterion or reporting, will. be serving cell for other UE while the other two base stations will be top neighbor cells.
All 3 devices are two different network slices:
   Serving cell signal strength <−105 dBm
   Serving cell interference <5 dB
   Condition timer up to 6 second consecutively
   1^{st} neighbor cell signal strength +/−3 dBm and interference +/−2 dB from serving cell.
   2^{nd} neighbor cell signal strength +/−6 dBm and interference +/−4 dB from serving cell
   Similar condition for other two UEs.
   In that case, first neighbor cell in above criterion or reporting, will be serving cell for other UE while the other two base stations will be top neighbor cells.
All 3 devices are part of 3 different network slices:
   Serving cell signal strength <−110 dBm
   Serving cell interference <5 dB
   Condition timer up to 10 second consecutively
   1^{st} neighbor cell signal strength +/−3 dBm and interference +/−2 dB from serving cell
   2^{nd} neighbor cell signal strength +/−6 dBm and interference +/−4 dB from serving cell.
   Similar condition for other two UEs.
   In that case, first neighbor cell in above criterion or reporting, will be serving cell for other UE while the other two base stations will be top neighbor cells.

It is noted that, because the RAM 30 is a component of the computing device 24, functionality implemented by the RAM 30 may be attributed to the computing device 24 generally. Moreover, in examples where the RAM 30 comprises software instructions that program the processor device 26 to carry out functionality discussed herein, functionality implemented by the RAM 30 may be attributed herein to the processor device 26.

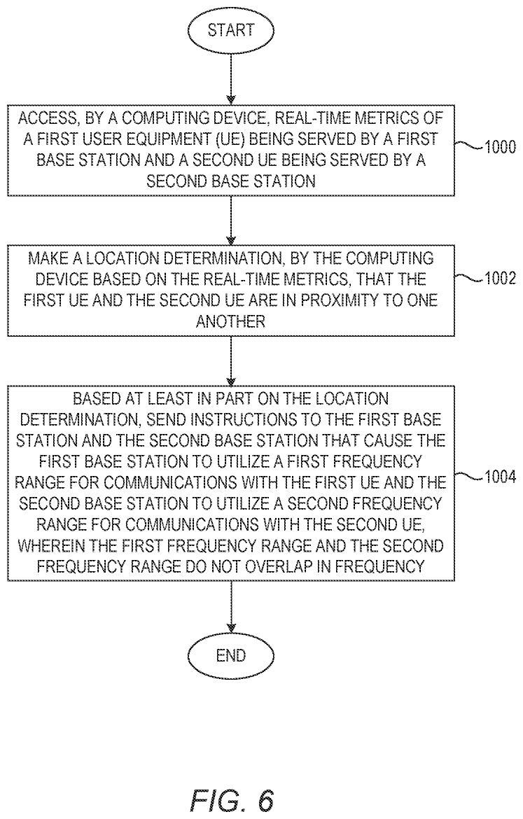

FIG. 6 is a flowchart of a method for frequency range allocation to reduce interference in user equipment in proximity to one another according to one implementation. FIG. 6 will be discussed in conjunction with FIG. 1. The computing device 24 accesses real-time metrics of the UE 22-1 being served by the base station 16-1 and the UE 22-2 being served by the base station 16-2 (FIG. 6, block 1000). The computing device 24 makes a proximity determination, based on the real-time metrics, that the UE 22-1 and the UE 22-2 are in proximity to one another (FIG. 6, block 1002). The computing device 24, based at least in part on the proximity determination, sends instructions to the base station 22-1 and the base station 22-2 that cause the base station 22-1 to utilize the frequency range 34 (FIG. 2) for communications with the UE 22-1 and the base station 22-2 to utilize the frequency range 36 for communications with the UE 22-2, wherein the frequency range 34 and the frequency range 36 do not overlap in frequency (FIG. 6, block 1004).

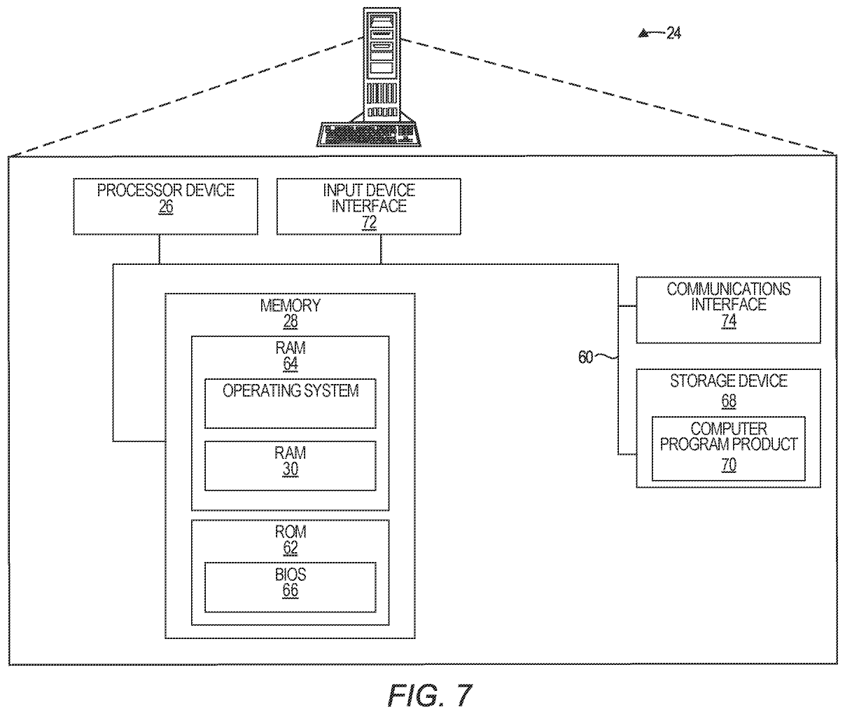

FIG. 7 is a block diagram of the computing device 24 suitable for implementing examples disclosed herein. The computing device 24 may comprise any computing or electronic device capable of including firmware, hardware, and/or executing software instructions to implement the functionality described herein, such as a computer server, a network switch, a base station 16, or the like. The computing device 24 includes the processor device 26, the system memory 28, and a system bus 60. The system bus 60 provides an interface for system components including, but not limited to, the system memory 28 and the processor device 26. The processor device 26 can be any commercially available or proprietary processor device.

The system bus 60 may be any of several types of bus structures that may further interconnect to a memory bus (with or without a memory controller), a peripheral bus, and/or a local bus using any of a variety of commercially available bus architectures. The system memory 28 may include non-volatile memory 62 (e.g., read-only memory (ROM), erasable programmable read-only memory (EPROM), electrically erasable programmable read-only memory (EEPROM), etc.), and volatile memory 64 (e.g., random-access memory (RAM)). A basic input/output system (BIOS) 66 may be stored in the non-volatile memory 62 and can include the basic routines that help to transfer information between elements within the computing device 24. The volatile memory 64 may also include a high-speed RAM, such as static RAM, for caching data.

The computing device 24 may further include or be coupled to a non-transitory computer-readable storage medium such as a storage device 68, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 68 and other drives associated with computer-readable media and computer-usable media may provide non-volatile storage of data, data structures, computer-executable instructions, and the like.

A number of modules can be stored in the storage device 68 and in the volatile memory 64, including an operating system and one or more program modules, such as the RAM 30, which may implement the functionality described herein in whole or in part. All or a portion of the examples may be implemented as a computer program product 70 stored on a transitory or non-transitory computer-usable or computer-readable storage medium, such as the storage device 68, which includes complex programming instructions, such as complex computer-readable program code, to cause the processor device 26 to carry out the steps described herein. Thus, the computer-readable program code can comprise software instructions for implementing the functionality of the examples described herein when executed on the processor device 26. The processor device 26, in conjunction with the RAM 30 in the volatile memory 64, may serve as a controller, or control system, for the computing device 24 that is to implement the functionality described herein.

An operator may also be able to enter one or more configuration commands through a keyboard (not illustrated), a pointing device such as a mouse (not illustrated), or a touch-sensitive surface such as a display device. Such input devices may be connected to the processor device 26 through an input device interface 72 that is coupled to the system bus 60 but can be connected by other interfaces such as a parallel port, an Institute of Electrical and Electronic Engineers (IEEE) 1394 serial port, a Universal Serial Bus (USB) port, an IR interface, and the like. The computing device 24 may also include a communications interface 74 suitable for communicating with the base stations 16 and other computing devices of the service provider 14.

Individuals will recognize improvements and modifications to the preferred examples of the disclosure. All such improvements and modifications are considered within the scope of the concepts disclosed herein and the claims that follow.

What is claimed is:

1. A method comprising:
accessing, by a computing device, real-time metrics of a first user equipment (UE) being served by a first base station and a second UE being served by a second base station;
making a proximity determination, by the computing device based on the real-time metrics, that the first UE and the second UE are in proximity to one another; and
based at least in part on the proximity determination, sending instructions to the first base station and the second base station that cause the first base station to utilize a first frequency range for communications with the first UE and the second base station to utilize a second frequency range for communications with the second UE, wherein the first frequency range and the second frequency range do not overlap in frequency.

2. The method of claim 1 wherein accessing the real-time metrics of the first UE being served by the first base station and the second UE being served by the second base station comprises receiving, by the computing device from the first base station and the second base station, the real-time metrics.

3. The method of claim 1 wherein the real-time metrics include serving cell signal strength, device location information, and neighbor cell signal strength.

4. The method of claim 1 wherein the real-time metrics include first location information that identifies a first location of the first UE and second location information that identifies a second location of the second UE and wherein making the proximity determination comprises:
determining that the first location of the first UE is within a predetermined distance from the second location of the second UE.

5. The method of claim 1 further comprising:
making, by the computing device, a signal quality determination based on the real-time metrics that the first UE and the second UE each have non-preferred signal characteristic values, and wherein sending the instructions to the first base station and the second base station is based at least in part on the proximity determination and the signal quality determination.

6. The method of claim 1 further comprising:
determining, by the computing device, that the first UE is associated with a first network slice and the second UE is associated with a second network slice;
determining that the second network slice has a higher quality of service (QOS) requirement than the first network slice; and
wherein sending the instructions to the first base station and the second base station that cause the first base station to utilize the first frequency range for communications with the first UE and the second base station to utilize the second frequency range for communications with the second UE, further comprises:
sending instructions to the first base station to utilize a first plurality of resource blocks for communications with the first UE; and
sending instructions to the second base station to utilize a second plurality of resource blocks for communications with the second UE, wherein a frequency gap comprising at least one resource block exists between the first plurality of resource blocks and the second plurality of resource blocks.

7. The method of claim 1 further comprising:
determining, by the computing device, that the first UE is associated with a first network slice and the second UE is associated with a second network slice;
accessing a first network slice trigger condition of a plurality of network slice trigger conditions, the first network slice trigger condition corresponding to a situation where the first UE and the second UE are associated with different network slices;
determining, by the computing device based on the real-time metrics, that both the first UE and the second UE have non-preferred values that characterize a signal condition of the first UE and the second UE; and
wherein sending instructions to the first base station and the second base station that cause the first base station to utilize the first frequency range for communications with the first UE and the second base station to utilize the second frequency range for communications with the second UE is based on the proximity determination and on determining that both the first UE and the second UE have the non-preferred values.

8. The method of claim 1 further comprising:
determining, by the computing device, that the first UE is associated with a first network slice that has a QOS requirement;
determining, by the computing device, that the first UE has a non-preferred value that characterizes a signal condition of the first UE; and
wherein sending the instructions to the first base station and the second base station that cause the first base station to utilize the first frequency range for communications with the first UE and the second base station to utilize the second frequency range for communications with the second UE is based on the proximity determination and on determining that the first UE has the non-preferred value.

9. The method of claim 1 further comprising:
subsequent to sending the instructions, accessing, by the computing device, subsequent real-time metrics of the first UE being served by the first base station and the second UE being served by the second base station;
making a subsequent proximity determination, by the computing device based on the subsequent real-time metrics, that the first UE and the second UE are in proximity to one another;
making a subsequent signal quality determination, by the computing device based on the subsequent real-time metrics, that the first UE and the second UE are each within a desired signal condition; and
in response to the subsequent signal quality determination, inhibiting sending instructions, to the first base station and the second base station, regarding frequency range utilization for communicating with the first UE and the second UE.

10. The method of claim 1 further comprising:
subsequent to sending the instructions, accessing, by the computing device, subsequent real-time metrics of the first UE being served by the first base station and the second UE being served by the second base station;
making a subsequent proximity determination, by the computing device based on the subsequent real-time metrics, that the first UE and the second UE are not in proximity to one another; and
in response to the subsequent proximity determination, inhibiting sending instructions, to the first base station and the second base station, regarding frequency range utilization for communicating with the first UE and the second UE.

11. A computing device, comprising:
a memory; and
a processor device coupled to the memory and operable to:
access real-time metrics of a first user equipment (UE) being served by a first base station and a second UE being served by a second base station;
make a proximity determination based on the real-time metrics that the first UE and the second UE are in proximity to one another; and
based at least in part on the proximity determination, send instructions to the first base station and the second base station that cause the first base station to utilize a first frequency range for communications with the first UE and the second base station to utilize a second frequency range for communications with the second UE, wherein the first frequency range and the second frequency range do not overlap in frequency.

12. The computing device of claim 11 wherein to access the real-time metrics of the first UE being served by the first base station and the second UE being served by the second base station, the processor device is further operable to receive, from the first base station and the second base station, the real-time metrics.

13. The computing device of claim 11 wherein the real-time metrics include first location information that identifies a first location of the first UE and second location information that identifies a second location of the second UE and wherein to make the proximity determination, the processor device is further operable to:
determine that the first location of the first UE is within a predetermined distance from the second location of the second UE.

14. The computing device of claim 11 wherein the processor device is further operable to:
make a signal quality determination based on the real-time metrics that the first UE and the second UE each have non-preferred signal characteristic values, and wherein sending the instructions to the first base station and the second base station is based at least in part on the proximity determination and the signal quality determination.

15. The computing device of claim 11 wherein the processor device is further operable to:
determine that the first UE is associated with a first network slice and the second UE is associated with a second network slice;
determine that the second network slice has a higher quality of service (QOS) requirement than the first network slice; and
wherein to send the instructions to the first base station and the second base station that cause the first base station to utilize the first frequency range for communications with the first UE and the second base station to utilize the second frequency range for communications with the second UE, the processor device is further operable to:
send instructions to the first base station to utilize a first plurality of resource blocks for communications with the first UE; and
send instructions to the second base station to utilize a second plurality of resource blocks for communications with the second UE, wherein a frequency gap comprising at least one resource block exists between the first plurality of resource blocks and the second plurality of resource blocks.

16. The computing device of claim 11 wherein the processor device is further operable to:
subsequent to sending the instructions, access subsequent real-time metrics of the first UE being served by the first base station and the second UE being served by the second base station;
make a subsequent proximity determination, based on the subsequent real-time metrics, that the first UE and the second UE are not in proximity to one another; and
in response to the subsequent proximity determination, inhibit sending instructions to the first base station and the second base station regarding frequency range utilization for communicating with the first UE and the second UE.

17. A non-transitory computer-readable storage medium that includes executable instructions operable to cause a processor device to:
access real-time metrics of a first user equipment (UE) being served by a first base station and a second UE being served by a second base station;
make a proximity determination based on the real-time metrics that the first UE and the second UE are in proximity to one another; and
based at least in part on the proximity determination, send instructions to the first base station and the second base station that cause the first base station to utilize a first frequency range for communications with the first UE and the second base station to utilize a second frequency range for communications with the second UE, wherein the first frequency range and the second frequency range do not overlap in frequency.

18. The non-transitory computer-readable storage medium of claim 17 wherein to access the real-time metrics of the first UE being served by the first base station and the second UE being served by the second base station, the instructions are further operable to cause the processor device to receive, from the first base station and the second base station, the real-time metrics.

19. The non-transitory computer-readable storage medium of claim 17 wherein the real-time metrics include first location information that identifies a first location of the first UE and second location information that identifies a second location of the second UE and wherein to make the proximity determination, the instructions are further operable to cause the processor device to:
determine that the first location of the first UE is within a predetermined distance from the second location of the second UE.

20. The non-transitory computer-readable storage medium of claim 17 wherein the instructions are further operable to cause the processor device to:
make a signal quality determination based on the real-time metrics that the first UE and the second UE each have non-preferred signal characteristic values, and wherein sending the instructions to the first base station and the second base station is based at least in part on the proximity determination and the signal quality determination.
